(19) United States
(12) Patent Application Publication
(10) Pub. No.: US 2004/0218623 A1
(43) Pub. Date: Nov. 4, 2004

(54) Hardware calculation of encapsulated IP, TCP and UDP checksums by a switch fabric channel adapter

(76) Inventors: Dror Goldenberg, Zichron Yaakov (IL); Michael Kagan, Zichron Yaakov (IL); Benny Koren, Zichron Yaakov (IL); Gil Stoler, Nofit (IL); Peter Paneah, Nesher (IL); Roi Rachamim, Haifa (IL); Gilad Shainer, Karkoor (IL); Rony Gutierrez, Haifa (IL); Sagi Rotem, Haifa (IL); Dror Bohrer, Nesher (IL)

Correspondence Address: Mark M Friedman, Dr Mark Friedman Ltd, C/O Discovery Dispatch, 9003 Florin Way, Upper Marlboro, MD, 20772, US

(21) Appl. No.: 10/428,477

(22) Filed: May 1, 2003

(51) Int. Cl. H04J 3/22

(52) U.S. Cl. 370/463; 370/466

(57) ABSTRACT

A network interface adapter includes a memory interface, for coupling to a memory containing a first data packet composed in accordance with a first communication protocol, and a network interface, for coupling to a packet communication network. Packet processing circuitry in the adapter reads the first data packet from the memory via the memory interface, computes a checksum of the first data packet, inserts the checksum in the first data packet in accordance with the first communication protocol, and encapsulates the first data packet in a payload of a second data packet in accordance with a second communication protocol applicable to the packet communication network, so as to transmit the second data packet over the network via the network interface. The circuitry likewise computes checksums of incoming encapsulated data packets from the network.

### FIELD OF THE INVENTION

The present invention relates generally to digital network communications, and specifically to network adapters for interfacing between a host processor and a packet data network.

### BACKGROUND OF THE INVENTION

The computer industry is moving toward fast, packetized, serial input/output (I/O) bus architectures, in which computing hosts and peripherals are linked by a switch fabric to form a system area network (SAN). A number of architectures of this type have been proposed, culminating in the “InfiniBand™” (IB) architecture, which has been advanced by a consortium led by a group of industry leaders (including Intel, Sun Microsystems, Hewlett Packard, IBM, Dell and Microsoft). The IB architecture is described in detail in the InfiniBand Architecture Specification, Release 1.1 (November, 2002), which is incorporated herein by reference. This document is available from the InfiniBand Trade Association at www.infinibandta.org.

Computing devices (hosts or peripherals) connect to the IB fabric via a network interface adapter, which is referred to in IB parlance as a channel adapter. The IB specification defines both a host channel adapter (HCA) for connecting a host processor to the fabric, and a target channel adapter (TCA), intended mainly for connecting peripheral devices to the fabric. Typically, the channel adapter is implemented as a single chip, with connections to the computing device and to the network. Client processes running on a computing device communicate with the transport layer of the IB fabric by manipulating a transport service instance, known as a “queue pair” (QP), made up of a send work queue and a receive work queue. The IB specification permits the HCA to allocate as many as 16 million (2²⁴) QPs, each with a distinct queue pair number (QPN). A given client process (referred to simply as a client) may open and use multiple QPs simultaneously.

To send and receive communications over the network, the client initiates work requests (WRs), which cause work items, called work queue elements (WQEs), to be placed in the appropriate queues. The channel adapter then executes the work items, so as to communicate with the corresponding QP of the channel adapter at the other end of the link. In both generating outgoing messages and servicing incoming messages, the channel adapter uses context information pertaining to the QP carrying the message. The QP context is created in a memory accessible to the channel adapter when the QP is set up, and is subsequently updated by the channel adapter as it sends and receives messages. After it has finished servicing a WQE, the channel adapter may write a completion queue element (CQE) to a completion queue in the memory, to be read by the client.

An IB fabric can be used as a data link layer to carry Internet Protocol (IP) traffic between hosts that are connected to the fabric, as well as between hosts on the IB fabric and hosts on other networks, via a suitable router or gateway. For this purpose, IP packets prepared for transmission by any of the participating hosts are encapsulated in IB messages by the corresponding HCA (typically messages of the Unreliable Datagram type), and are then de-encapsulated by the HCA of the receiving host. This type of service is referred to as IP over IB service, or IPoIB for short. It is substantially transparent to the hosts, in the sense that IP packets can be carried over the IB fabric in this way without requiring any changes to the well-known conventions of IP or higher-level protocols. IPoIB encapsulation of IP packets is described by Kashyap and Chu in an Internet Draft entitled “IP Encapsulation and Address Resolution over InfiniBand Networks,” published as draft-ietf-ipoib-ip-over-infiniband-01 (2002) by the Internet Engineering Task Force (IETF), which is incorporated herein by reference. This document, as well as the various Request for Comments (RFC) documents mentioned below, is available at www.ietf.org.

IP version 4 (IPv4) and the transport-layer protocols commonly carried over IP—the Transmission Control Protocol (TCP) and the User Datagram Protocol (UDP)—all include a checksum in the packet header, for use by receiving nodes in verifying that the packet contents (header and payload) are correct. Computation of the checksum is defined as follows by Braden et al., in IETF RFC 1071 (1988), entitled “Computing the Internet Checksum”:

(1) Adjacent octets to be checksummed are paired to form 16-bit integers, and the 1's complement sum of these 16-bit integers is formed. If the segment to be checksummed contains an odd number of octets, it is temporarily padded on the right with zeros for the purpose of computing the checksum.

(2) To generate a checksum, the checksum field itself is cleared in the packet header, the 16-bit 1's complement sum is computed over the octets concerned, and the 1's complement of this sum is placed in the checksum field.

(3) To check a checksum, the 1's complement sum is computed over the same set of octets, including the checksum field. If the result is all 1 bits (0 in 1's complement arithmetic), the check succeeds.

In the IPv4 header, the checksum is computed over the header only. In the TCP and UDP headers, the checksum is taken over the entire TCP or UDP header and payload data, together with a “pseudo-header” that includes a subset of the IP header fields. Details of the IPv4, TCP and UDP headers, including the checksums, are provided in the following RFC documents, all by Postel, which were promulgated by the Defense Advanced Research Projects Agency (DARPA): RFC 791—“Internet Protocol” (1981); RFC 768—“User Datagram Protocol” (1980); and RFC 793—“Transmission Control Protocol” (1981). All these documents are incorporated herein by reference. Note that the IP version 6 (IPv6) header contains no checksum field. Computation of the IPv6 pseudo-header for purposes of TCP and UDP is described in IETF RFC 2460, entitled “Internet Protocol, Version 6 (IPv6) Specification” (1998), which is also incorporated herein by reference.

### SUMMARY OF THE INVENTION

It is an object of some aspects of the present invention to provide improved methods and devices for computing checksums in encapsulated data packets, and particularly in IPoIB packets.

In preferred embodiments of the present invention, a network interface adapter links a host processor to a switch fabric that operates in accordance with a predetermined protocol. Alternatively, the network interface adapter and processor may be part of an embedded system in a device such as a router or gateway. Typically the switch fabric is an IB fabric, and the network interface adapter is a HCA. The host processor prepares packet data and headers in a system memory in accordance with another protocol, typically IP, and submits work requests to the adapter, indicating that the packets are to be encapsulated and transmitted over the fabric by the adapter.

In order to conserve its computing resources, the host processor does not compute the required IPv4 and transport-layer checksums (although it may perform a partial calculation, such as computing the IP pseudo-header and placing it in the TCP or UDP checksum field). Instead, as the adapter reads the packet data and headers from the system memory, it computes the required checksums, and then inserts the computed checksums at the appropriate points in the IP and transport-layer headers (replacing partial computation results that may have been prepared by the host processor). The adapter preferably performs the checksum computation on the fly, in parallel with direct memory access (DMA) reading of the data and headers, so that almost no additional latency in transmitting the message is incurred on account of the checksum computation, and no additional memory bandwidth is required beyond that already used for the DMA operation.

Preferably, when the adapter receives an encapsulated IP packet from the fabric, it similarly calculates checksums on the fly. If the adapter detects a checksum error, in the IPv4 checksum, for example, it may, depending on configuration, either discard the packet or submit the packet to the host processor with an indication that a checksum error has occurred. Additionally or alternatively, the adapter may compute a checksum, typically over the entire IP payload of the incoming packet, and pass the result to the host processor, which then completes the checksum processing in software. Typically, in the IB context, the HCA reports the checksum error and/or passes the result of the checksum computation to the host processor in a CQE that the HCA writes to an appropriate completion queue in the system memory.

Although the preferred embodiments described herein relate specifically to computation of IP, TCP and UDP checksums, the principles of the present invention may be applied to computation of error detection codes, such as checksums and cyclic redundancy codes (CRCs), mandated by other protocols, as well, in messages that are encapsulated for transmission over a switch fabric.

There is therefore provided, in accordance with an embodiment of the present invention, a network interface adapter, including:

a memory interface, for coupling to a memory containing a first data packet composed in accordance with a first communication protocol;

a network interface, for coupling to a packet communication network; and

packet processing circuitry, which is adapted to read the first data packet from the memory via the memory interface, to compute a checksum of the first data packet and to insert the checksum in the first data packet in accordance with the first communication protocol, and to encapsulate the first data packet in a payload of a second data packet in accordance with a second communication protocol applicable to the packet communication network, so as to transmit the second data packet over the network via the network interface.

In a preferred embodiment, the first communication protocol includes a transport protocol that operates over an Internet Protocol (IP), wherein the checksum includes at least one of an IP checksum, a Transmission Control Protocol (TCP) checksum and a User Datagram Protocol (UDP) checksum.

In some embodiments, the packet communication network includes a switch fabric. In accordance with the second communication protocol, the packet processing circuitry is adapted to transmit and receive data packets over the packet communication network using one or more queue pairs, including a selected queue pair over which the second data packet is to be transmitted, and the packet processing circuit is adapted to receive an indication that the selected queue pair is to be used for encapsulating and transmitting at least the first data packet composed in accordance with the first communication protocol, and to compute and insert the checksum responsive to the indication. Preferably, the packet processing circuitry is adapted to encapsulate the first data packet in the payload of the second data packet substantially as defined in a document identified as draft-ietf-ipoib-ip-over-infiniband-01, published by the Internet Engineering Task Force.

Typically, the network interface has a wire speed, and the packet processing circuitry is adapted to compute the checksum at a rate that is at least approximately equal to the wire speed. Preferably, the wire speed is substantially greater than 1 Gbps.

In a preferred embodiment, the packet processing circuitry is adapted to read a descriptor from the memory via the memory interface and to generate the second data packet based on the descriptor, while determining whether or not to compute and insert the checksum in the first data packet responsive to a corresponding data field in the descriptor.

Additionally or alternatively, the packet processing circuitry is adapted to parse a header of the first data packet so as to identify a protocol type to which the first data packet belongs, and to compute the checksum appropriate to the identified protocol type. Preferably, the first data packet has an encapsulation header appended thereto, and the packet processing circuitry is adapted to identify the protocol type by reading a field in the encapsulation header. Further additionally or alternatively, the processing circuitry is adapted, in accordance with the protocol type, to compute both a network layer protocol checksum and a transport layer protocol checksum, and to insert both the network layer protocol checksum and the transport layer protocol checksum in a header of the first data packet.

In a preferred embodiment, the packet processing circuitry includes an execution unit, which is adapted to read from the memory descriptors corresponding to messages to be sent over the network, and to generate gather entries defining packets to be transmitted over the network responsive to the work items; and a send data engine, which is adapted to read data from the memory for inclusion in the first data packet responsive to one or more of the gather entries, while computing the checksum. Preferably, the execution unit is further adapted, based on the descriptors, to generate a header of the second data packet in accordance with the second communication protocol. Additionally or alternatively, the send data engine includes a direct memory access (DMA) engine, which is adapted to read a succession of lines of the data from the memory, and to write the lines of the data to a buffer; and a checksum computation circuit, which is coupled to receive the lines of the data in the succession from the DMA engine, to compute the checksum while the DMA engine is reading the succession of lines of the data from the memory, and to insert the checksum at a location in the first data packet designated in accordance with the first communication protocol when the DMA engine has completed reading the succession of lines of the data.

In an alternatively embodiment, the packet processing circuitry includes a send data engine, which is adapted to read data from the memory for inclusion in the first data packet, and using the data, to construct the second data packet, encapsulating the first data packet; an output buffer, which is coupled to receive the second data packet from the send data engine; and a checksum computation circuit, which is adapted to compute the checksum and to insert the checksum in the first data packet as the second data packet is transmitted out of the output buffer onto the network. Preferably, in accordance with the second communication protocol, the packet processing circuitry is adapted to transmit and receive data packets over the packet communication network using multiple queue pairs, including at least a first queue pair over which the second data packet is to be transmitted and a second queue pair for the data packets that are not to be used for encapsulating the first data packet, and the send data engine is adapted, upon constructing the data packets for transmission over the second queue pair, to send the data packets directly for transmission onto the network while bypassing the output buffer.

Typically, the packet processing circuitry is further adapted to receive from the network a third data packet encapsulating a fourth data packet as the payload of the third data packet, and to calculate one or more checksums in the fourth data packet in accordance with the first communication protocol.

There is also provided, in accordance with an embodiment of the present invention, a network interface adapter, including:

a memory interface, for coupling to a memory;

a network interface, which is adapted to be coupled to a packet communication network so as to receive from the network a second data packet in accordance with a second communication protocol applicable to the packet communication network, the second data packet encapsulating a first data packet composed in accordance with a first communication protocol; and

packet processing circuitry, which is coupled to receive the second data packet from the network interface, to compute a checksum of the first data packet in accordance with the first communication protocol, and to write the first data packet to the memory via the memory interface, together with an indication of the checksum.

Preferably, the packet processing circuitry is adapted to compare the computed checksum to a checksum field in a header of the first data packet, so as to verify the checksum field, and the indication of the checksum indicates whether the checksum field was verified as correct. Optionally, the packet processing circuitry is adapted to determine a disposition of the first data packet responsively to verifying the checksum, wherein the packet processing circuitry is adapted to discard the second data packet when the checksum is found to be incorrect.

Typically, the network interface has a wire speed, and the packet processing circuitry is adapted to compute the checksum at a rate that is at least approximately equal to the wire speed.

Preferably, the packet processing circuitry is adapted to parse a header of the first data packet so as to identify a protocol type to which the first data packet belongs, and to compute the checksum in accordance with the identified protocol type. Most preferably, the first data packet has an encapsulation header appended thereto, and the packet processing circuitry is adapted to identify the protocol type by reading a field in the encapsulation header.

In a preferred embodiment, the packet processing circuitry is adapted to write a completion report to the memory, indicating whether or not the checksum was found to be correct. Alternatively or additionally, the packet processing circuitry is adapted to write a completion report to the memory and to insert the computed checksum in the completion report, for use by a host processor in verifying a checksum field in the header of the first packet.

In a further embodiment, the second data packet is one of a sequence of second data packets, which encapsulate respective fragments of the first data packet, and wherein the packet processing circuitry is adapted to compute respective partial checksums for all fragments as the packet processing circuitry receives the second data packets, and to sum the partial checksums in a checksum arithmetic operation in order to determine the checksum of the first data packet. Preferably, the adapter includes a send data engine, which is adapted to generate the second data packets for transmission over the network in accordance with the second communication protocol, and an output port, which is coupled to loop back the second data packets to the packet processing circuitry, so as to cause the packet processing circuitry to determine the checksum of the first data packet, for insertion of the checksum in an initial second data packet in the sequence before transmission of the sequence of the second data packets over the network.

There is additionally provided, in accordance with an embodiment of the present invention, a method for coupling a host processor and a system memory associated therewith to a network, including:

reading from the system memory, using a network interface adapter device, a first data packet composed by the host processor in accordance with a first communication protocol; and

performing the following steps in the network interface adapter device:

computing a checksum of the first data packet;

inserting the checksum in the first data packet in accordance with the first communication protocol;

encapsulating the first data packet in a payload of a second data packet in accordance with a second communication protocol applicable to the network; and

transmitting the second data packet over the network.

There is further provided, in accordance with an embodiment of the present invention, a method for coupling a host processor and a system memory associated therewith to a network, including:

receiving from the network, using a network interface adapter device, a second data packet in accordance with a second communication protocol applicable to the network, the second data packet encapsulating a first data packet composed in accordance with a first communication protocol; and

performing the following steps in the network interface adapter device:

computing a checksum of the first data packet in accordance with the first communication protocol; and

writing the first data packet to the memory together with an indication of the checksum.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a system for network communications, in accordance with a preferred embodiment of the present invention;

FIG. 2 is a block diagram that schematically illustrates the structure of an IPoIB data packet transmitted in the system of FIG. 1;

FIG. 3 is a block diagram that schematically illustrates a host channel adapter (HCA), in accordance with a preferred embodiment of the present invention;

FIG. 4A is a block diagram that schematically shows details of a gather engine used in the HCA of FIG. 3, in accordance with a preferred embodiment of the present invention;

FIG. 4B is a block diagram that schematically shows details of an output port in the HCA of FIG. 3, in accordance with an alternative embodiment of the present invention; and

FIG. 5 is a block diagram that schematically shows details of elements of the HCA of FIG. 3 that are used in processing incoming IPoIB packets, in accordance with a preferred embodiment of the present invention.

### DETAILED DESCRIPTION OF PREFERRED EMBODIMENTS

FIG. 1 is a block diagram that schematically illustrates an IB network communication system 20, in accordance with a preferred embodiment of the present invention. In system 20, a host 21 comprises a HCA 22, which couples a host processor 24 to an IB fabric 26. Typically, processor 24 comprises an Intel Pentium™ processor or other general-purpose computing device with suitable software. Alternatively, HCA 22 and processor 24 may be part of an embedded system in a device such as a router or gateway. HCA 22 communicates via fabric 26 with other HCAs, such as a remote HCA 28 with a remote host 30, as well as with TCAs (not shown) connected to peripheral devices. HCA 22 may also communicate via fabric 26 with hosts on another network 31, such as an Ethernet IP network, which is coupled to fabric 26 by a suitable gateway 29 or router, as is known in the art.

Host processor 24 and HCA 22 are connected to a system memory 32 via a suitable memory controller 34, or chipset, as is known in the art. The HCA and memory typically occupy certain ranges of physical addresses in a defined address space on a bus connected to the controller, such as a Peripheral Component Interface (PCI) bus, or a PCIX, PCI Express or Rapid I/O bus. In addition to the host operating system, applications and other data (not shown explicitly in the figure), memory 32 holds certain data structures that are accessed and used by HCA 22. These data structures preferably include QP context information 36, and descriptors 38 corresponding to WQEs to be carried out by HCA 22. The HCA also writes completion reports 40, or CQEs, to memory 32, where they may be read by the host. HCA 22 may also have a locally-attached memory 23 in which QP context information 36 and other data may be held for rapid access by the HCA.

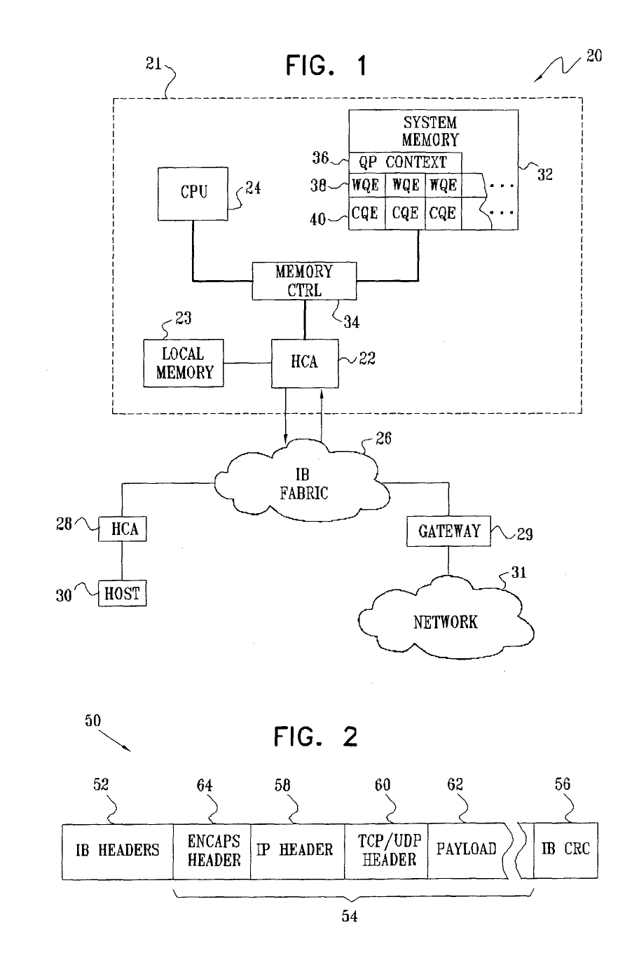

FIG. 2 is a block diagram that schematically illustrates an IPoIB packet 50 generated by HCA 22 for transmission over fabric 26, in accordance with a preferred embodiment of the present invention. Packet 50 comprises IB headers 52, as required by the IB specification, an IB payload 54 containing the encapsulated IP packet, and cyclic redundancy codes (CRCs) 56 used for IB error detection. The IP packet comprises an IP header 58, followed by a transport header 60, typically a TCP or UDP header, and a payload 62. As noted above, if the IP packet is an IPv4 packet, IP header 58 includes a checksum. Transport header 60 includes its own checksum in any case, covering the transport header, payload 62 and the IP pseudo-header (although this checksum may optionally be omitted in UDP packets).

An encapsulation header 64 is added to IB payload 54 before the actual IP header 58, in order to identify the type of packet that is encapsulated in the IB payload. Kashyap and Chu, in the above-mentioned Internet draft, propose a four-byte encapsulation header structure that may be used for this purpose. The encapsulation header identifies the encapsulated packet as an IPv4 or IPv6 packet. (The encapsulation header can also be used to identify ARP and RARP packets that are encapsulated and transmitted over the IB fabric, but these packet types are beyond the scope of the present invention. The checksum calculation and checking functions of HCA 22 are described hereinbelow only with respect to TCP/IP and UDP/IP packets, although these functions could be extended, mutatis mutandis, to packets of other types, such as ICMP, ARP and RARP packets.)

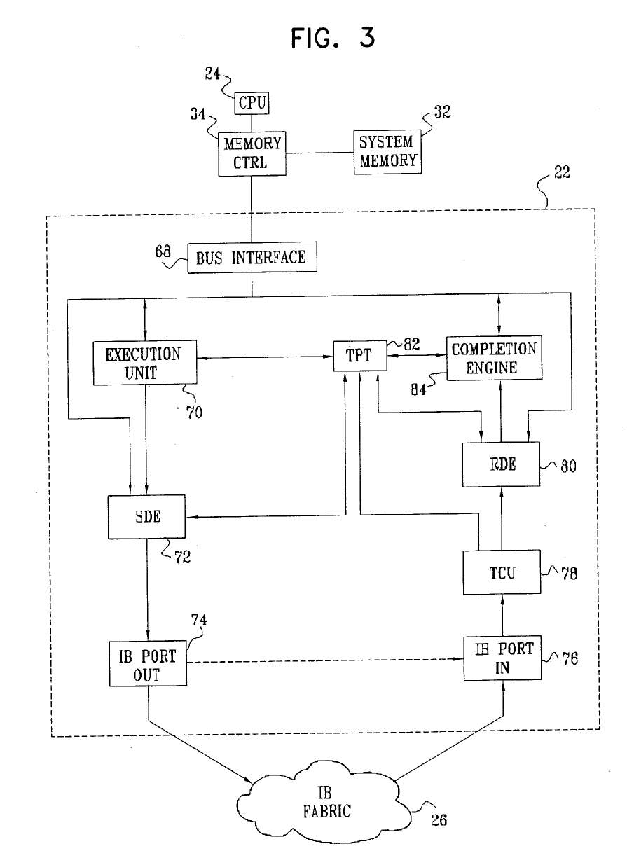

FIG. 3 is a block diagram that schematically shows details of HCA 22, in accordance with a preferred embodiment of the present invention. For the sake of simplicity, not all of the interconnections between the blocks are shown in the figure, and some blocks that would typically be included in HCA 22 but are inessential to an understanding of the present invention are omitted. The blocks and links that must be added will be apparent to those skilled in the art. The various blocks that make up HCA 22 may be implemented either as hardware circuits or as software processes running on a programmable processor, or as a combination of hardware and software-implemented elements. In particular, functions of RCA 22 that are associated with IPoIB checksum computation, as described below, are preferably carried out by hardware logic for the sake of processing speed (enabling checksum processing to be carried out at or near the wire speed of fabric 26). On the other hand, although certain other functional elements of HCA 22 are shown as separate blocks in the figures for the sake of conceptual clarity, the functions represented by these blocks may actually be carried out by different software processes on a single. processor. Preferably, all of the elements of the HCA are implemented in a single integrated circuit chip, but multi-chip implementations are also within the scope of the present invention.

In order to send out packets from HCA 22 on a given QP over network 26, host 24 posts WQEs 38 for the QP by writing descriptors in memory 32, indicating the source of data to be sent and its destination. The data source information typically includes a “gather list,” pointing to the locations in memory 32 from which the data to insert in the IB payload of the outgoing message are to be taken. Preferably, host 24 selects one or more specific QPs to use for sending and receiving IPoIB packets and identifies these QPs by setting a predetermined flag in QP context 36 for these QPs. The flag alerts HCA 22 that in addition to the operations that it normally performs in sending and receiving packets over fabric 26, the HCA may be required to perform additional operations on the packets in this QP that are specific to IPoIB. One of these operations may be automatic checksum calculation and insertion of the calculated result in the proper header field of outgoing packets. Preferably, host 24 sets specific flags in the descriptors that it prepares with respect to each of the outgoing IPoIB packets to indicate to the HCA whether it should calculate the IP checksum, or the TCP or UDP checksum, or both the IP and TCP/UDP checksums if relevant.

After host 24 has prepared one or more descriptors, it “rings a doorbell” of HCA 22, by writing to a corresponding doorbell address occupied by the HCA in the address space on the host bus. The doorbell causes an execution unit 70 to queue the QPs having WQEs that are awaiting service, and then to process the WQEs. Based on the corresponding descriptors, execution unit 70 generates “gather entries” defining the IB packets that the HCA must transmit in order to fulfill each WQE, including the data to collect from memory 32 for insertion in each packet. For IPoIB packets, flags set in the descriptors also indicate which checksums must be calculated by the HCA.

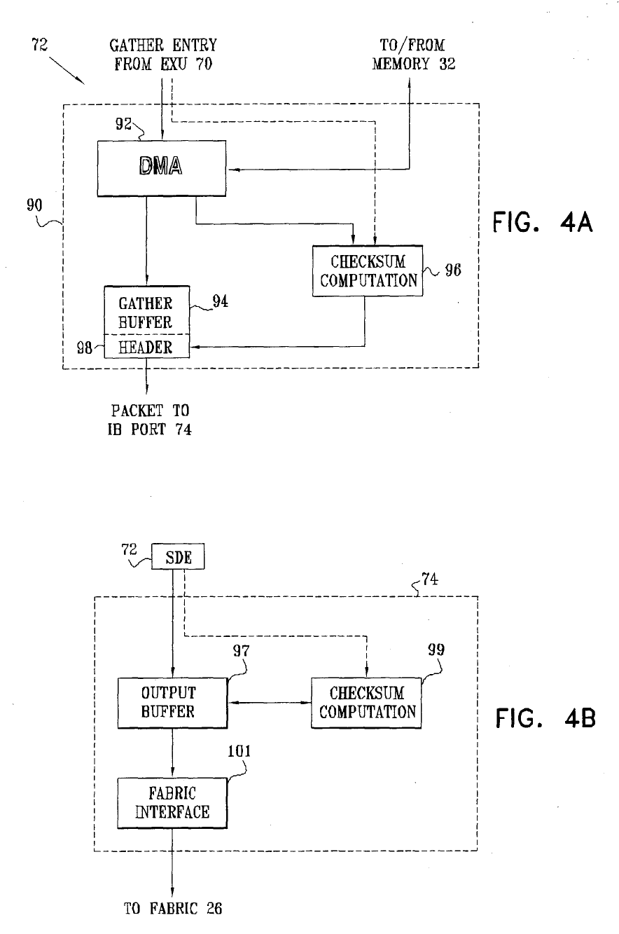

Execution unit 70 submits the gather entries to a send data engine (SDE) 72, together with other instructions, based on the descriptors, defining the IB packet header fields and indicating other operations to be performed, such as checksum calculation. The SDE gathers the data to be sent from the locations in memory 32 specified by the descriptors, accessing the memory with the help of a translation protection table (TPT) 82. (The TPT provides information for the purpose of address translation and protection checks to control access to memory 32.) SDE 72 places the data in output packets for transmission over network 26, adds headers to the packets, and calculates checksums if the instructions from the execution unit so indicate. These functions of the SDE are described in greater detail hereinbelow with reference to FIG. 4. The data packets prepared by SDE 72 are passed to an output port 74, which performs data link operations and other necessary functions, as are known in the art, and sends the packets out over network 26. The wire speed of the link between port 74 and network 26 is typically in excess of 1 Gbps, and it may be as high as 10 Gbps, in accordance with the IB specification. The output port may also loop certain packets, such as multicast packets and other packets addressed to local destinations, back to an input port 76 of HCA 22.

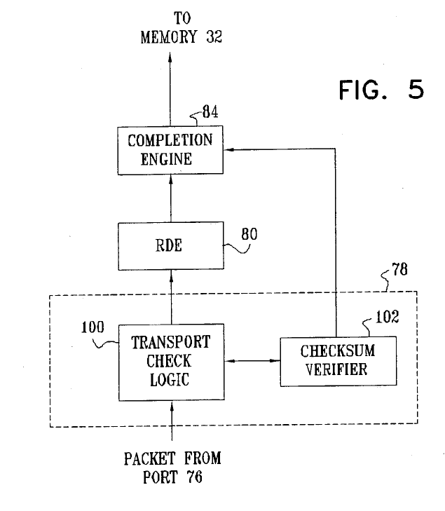

Packets sent to HCA 22 over network 26 are received (at a wire speed similar to that of output port 74) at input port 76, which likewise performs data link and buffering functions. A transport check unit (TCU) 78 processes and verifies IB transport-layer information contained in the incoming packets. In addition, the TCU may be configured to compute the IP and/or TCP/UDP checksums of IPoIB packets, as well as to check the IP checksums, as described in greater detail hereinbelow with reference to FIG. 5. The TCU passes IB payload data to a receive data engine (RDE) 80, which scatters the data to memory 32, using the information in TPT 82. In order to handle IB send requests, RDE 80 uses receive WQEs posted by processor 24, indicating the locations in memory 32 to which the message payload data are to be scattered. When the RDE finishes scattering the data, a completion engine 84 writes a CQE to memory 32. For IPoIB packets, the CQE also includes checksum information, as described below.

Channel adapters similar to HCA 22 are described in U.S. patent application Ser. No. 10/000,456, filed Dec. 4, 2001, and in U.S. patent application Ser. No. 10/052,435, filed Jan. 23, 2002. Both of these applications are assigned to the assignee of the present patent application, and their disclosures are incorporated herein by reference. The methods described hereinbelow for handling IPoIB packets may similarly be implemented in the channel adapters described in these patent applications. It should be understood, however, that the details of HCA 22 that are described in the present patent application and in these prior applications are brought here by way of example. Implementation of the present invention is not limited to the exemplary structure and operational flow of the HCA shown here, and alternative implementations are considered to be within the scope of the present invention.

FIG. 4A is a block diagram that schematically shows details of SDE 72, in accordance with a preferred embodiment of the present invention. (This embodiment is one possible implementation of on-the-fly IPoIB checksum calculation. An alternative implementation, wherein the checksum is calculated by output port 74, is shown in FIG. 4B and described with reference thereto.) The SDE preferably comprises a number of gather engines working in parallel to process the gather entries generated by execution unit 70, with suitable arbitration mechanisms for distributing the gather entries among the gather engines and for passing the completed packets on to IB output port 74. One gather engine 90 is shown in FIG. 4 by way of example.

Each gather engine 90 comprises a direct memory access (DMA) engine 92, which assembles data packets in a packet buffer 94 in accordance with the gather entry instructions. Typically, gather entries either contain “inline” data (such as header contents prepared by execution unit 70), which DMA engine 92 writes directly to buffer 94, or they contain a pointer to the location of data to be read by the DMA engine from memory 32. Before accessing memory 32, the gather engine performs protection checks and virtual-to-physical address translation using TPT 82. The execution engine also provides side signals (control fields and flags) to control the operation of gather engine 90, including checksum flags that may be set by execution unit 70 to instruct the gather engine to compute and insert IP and/or transport header (TCP/UDP) checksums in IPoIB packets.

The checksum computations are carried out by checksum computation logic 96 in gather engine 90. (Alternatively, these operation may be carried out in output port 74, as described below.) When IPoIB checksums are to be computed, logic 96 tracks the lines of IB payload data reads from memory 32 by DMA engine 92. The checksum flags indicate to logic 96 whether it is to compute the IP, TCP or UDP checksum, or both the IP and TCP/UDP checksums. The first line of data that logic 96 reads in IB payload 54 (FIG. 2) for each IPoIB packet is encapsulation header 64. This header indicates to logic 96 whether the current packet is an IPv4 or IPv6 packet or a packet of a different type. In the case of IPv6 packets, there is no IP header checksum to compute, and logic 96 therefore simply scans through the lines of IP header 58 in order to locate transport header 60 (TCP or UDP) that follows.

For IPv4 packets, logic 96 sums the bits in each line of data in the prescribed manner, as described in the Background of the Invention. The summing operation is preferably performed at the full data path width (typically 128 bits), as the data enter buffer 94, so that the computation proceeds at wire speed. Since the checksum operation is associative, each subsequent line received by logic 96 can simply be summed with the checksum obtained up to and including the preceding line, until the entire checksum has been computed. The standard IHL field of the IP header indicates to logic 96 how many words to expect (in 4-byte units), and the logic terminates the IP checksum computation when it has processed the requisite number of words. Logic 96 inserts the checksum value at the header checksum field location in a header section 98 of the packet as the packet exits buffer 94 to output port 74.

To compute the TCP or UDP checksum, logic 96 first extracts and sums the appropriate pseudo-header fields from IP header 58. For this purpose, logic 96 must parse the IP header and (in the case of IPv6) its extended headers, using the parsing procedures shown below in Table I. Alternatively, the function of computing the pseudo-header checksum may be performed in advance, under software control, by processor 24. In this case, the processor may insert the pseudo-header checksum in the checksum field of the TCP or UDP header.

Logic 96 then continues the checksum computation over transport header 60 and payload 62, adding in zeros to pad the final word if necessary. The result is added to the pseudo-header checksum (using appropriate checksum arithmetic, as is known in the art). Logic 96 then inserts the full TCP or UDP checksum value in its location in header section 98 as the packet exits buffer 94. Since both the IP and TCP/UDP checksum computations are performed on the fly, in line with reading the IB payload data from memory 32, the checksum operations carried out by gather engine 90 add no more than a few clock cycles of latency in generating IPoIB packets.

Table I below presents the operation of checksum computation logic 96 in pseudocode form. The “Lreq” field referred to in the table is a side signal that contains the flags that are set by execution unit 70 to indicate the checksums that are to be computed for each packet.

TABLE I
CHECKSUM COMPUTATION

Wait for Start of IPoIB Packet

Parse IB Headers until you get to IB Payload;
If (Encapsulation_Header.Type ==IPv4 (0x800))

Call Parse_IPv4;
If (Lreg.IP) call IPv4_Checksum;

Else If (Encapsulation_Header.Type ==IPv6 (0x86DD))

Call Parse_IPv6;

Else Break;
If (Lreq.TCP_UDP &&

IP_Header.Protocol (Last header in case of

IPv6) ==TCP(0x6))

Call Gen_TCP_Checksum;

If (Lreq.TCP_UDP &&

IP_Header.Protocol (Last header in case of

IPv6) ==UDP(0x11))

Call Gen_UDP_Checksum;

Parse_IPv4:

Skip IHL DWORDs; /* DWORD = 32 bits */
Return;

IPv4_Checksum:

Assume IP_Header.Header_Checksum = 0;
Calculate Header_Checksum on all the IP header as

indicated by IP_Header.IHL;

Write Header_Checksum;
Return;

Gen_UDP_Checksum:

Calc Checksum on UDP packet including the checksum

field which holds the pseudo-header checksum;

If (checksum ==0x0)

checksum =0xffff;

Write it in UDP_Header.Checksum;
Return;

Gen_TCP_Checksum:

Calc Checksum on TCP packet including the checksum

field which holds the pseudo-header checksum;

Write it in TCP_Header.Checksum;
Return;

Parse_IPv6:

Parse IPv6_Base_header;
Current_Header.Next_Header

=IPv6_Base_header.Next_Header;

While (Current_Header.Next_Header ==Hop-by-Hop

Options Header | |

Current_Header.Next_Header == Routing

Header| |

Current_Header.Next_Header == Destination

Options Header | |

Current_Header.Next_Header == Authentication

Header | |

Current_Header.Next_Header == Fragment

Header| |) {
Skip Current_Header;
Current_Header = Next_Header;

};

Return;

FIG. 4B is a block diagram that schematically shows details of output port 74, in accordance with an alternative embodiment of the present invention. In this case, the IPoIB checksums may also be computed by IB output port 74. This approach may be easier to implement than the approach illustrated in FIG. 4A, although computing the checksum in the output port adds a small amount of latency to the IPoIB packet transmission, due to the additional store and forward of each packet in the output port while the checksums are computed.

For each IPoIB packet, SDE 72 signals port 74 to indicate which checksum fields in the IP and TCP/UDP headers must be computed. To perform the computation, the IPoIB packet is read into in an output buffer 97 in port 74, while a dedicated checksum computation unit 99 computes the checksums, as described above. The checksum computation unit then inserts the checksums in the proper locations in the packet as the packet exits buffer 97 to fabric 26 via a fabric interface 101. Other (non-IPoIB) packets, which do not require computation of an encapsulated checksum, are preferably passed from SDE 72 directly to fabric interface 101, bypassing buffer 97 with no added latency.

FIG. 5 is a block diagram that schematically shows details of elements of HCA 22 that are used in processing incoming IPoIB packets, in accordance with a preferred embodiment of the present invention. Transport check logic 100 in TCU 78 receives incoming packets from IB input port 76 and checks the information in IB headers 52, as required by the IB specification. To check the header information, logic 100 refers to QP context 36 (relevant parts of which are preferably cached on the HCA chip) for the destination QP of the incoming packet. The QP context indicates, inter alia, whether the destination QP is carrying IPoIB packets and, if so, whether TCU 78 is required to check the checksums of these packets.

If transport check logic 100 successfully verifies that the IB header information of an incoming IPoIB packet is correct, it passes IB payload 54 to RDE 80 to be written to memory 32. In addition, for IPoIB packets that require checksum checking, logic 100 passes the IB payload to a checksum verifier 102. Verifier 102 operates in a manner similar to checksum computation logic 96, except that verifier 102 does not insert the result of its computation in the packet itself, but rather passes the result to completion engine 84. As in the case of logic 96, verifier 102 may operate in parallel with logic 100 in order to reduce or eliminate any added latency in processing incoming packets due to checksum processing.

Verifier 102 reads encapsulation header 64 to determine whether the packet encapsulated in the IB payload is an IPv4 or an IPv6 packet. It checks IPv4 checksums by taking the 1's complement sum of IP header 58 of the incoming packet, including the checksum field. It may then check the TCP or UDP checksum by finding the 1's complement sum of transport header 60, including the checksum field, together with payload 62 and the pseudo-header fields from IP header 58. If the result in each case is all 1 bits, the check succeeds. If an IP packet is fragmented into a sequence of two or more IP fragments (as indicated by the IP header), verifier 102 checks only the IP checksums (for all fragments), but does not calculate the TCP or UDP checksum. Instead, verifier 102 computes a checksum value for the entire IP payload of each fragment and passes the value to completion engine 84 for reporting to the host processor. The host processor reassembles the IP packet and calculates the total checksum based on the checksum values calculated by the HCA for all the fragments.

When RDE 80 has successfully written IB payload 54 to memory 32, it signals completion engine 84, which then writes a CQE to memory 32. Preferably, the CQE includes one or more checksum flags, which are set by checksum verifier 102 to indicate that the IP and TCP/UDP checksums were found to be correct (assuming that verifier 102 is configured to check both these checksums). Host processor 24 reads the checksum flags in the CQE to verify that the IP packet referred to by the CQE was received in good order. If the flag is not set, processor 24 may decide to drop the IP packet or, if appropriate, may signal the remote host that sent the packet (by sending a TCP NACK, for example), to resend the packet. To avoid rejecting valid packets, processor 24 may choose to recheck the checksums of packets regarding which HCA 22 reported checksum errors.

Alternatively or additionally, if checksum verifier 102 determines that any of the checksums in an incoming IPoIB packet were incorrect, it may signal transport check logic 100 to drop the packet.

As a further alternative, the QP context for a given IPoIB QP may indicate that TCU 78 is not to perform IP or TCP/UDP checksum checking, or HCA 22 may simply be configured to perform checksum computation but not checksum checking (for either IP or TCP/UDP, or both) for all QPs. In this case, verifier 102 preferably computes a checksum and passes it to completion engine 84, which inserts the checksum into a predetermined field into the CQE that it generates with respect to this packet, for use by host processor 24 in verifying the packet.

For example, verifier 102 may be configured to verify the IP checksum (for IPv4), but only to calculate and not verify the TCP or UDP checksum. In this case, the verifier computes the IPv4 checksum for each incoming IPoIB packet and instructs completion engine 84 to set an IP_OK flag in the CQE if the checksum is correct. In addition, if the IP checksum is correct, the verifier computes a checksum over all of the IP payload, and passes this value to the completion engine for insertion in the CQE. Upon reading the CQE, host processor 24 determines the IP pseudo-header fields, computes the checksum value for these fields, and adds it to the checksum provided by the CQE to find the complete TCP or UDP checksum. The host processor checks this value against the checksum appearing in the TCP or UDP header in order to verify that the packet contents are correct. Alternatively, if verifier 102 finds that the IPv4 checksum is incorrect, it instructs the completion engine to reset the IP_OK flag in the CQE for this packet. The verifier may pass the checksum of the entire IBoIP packet payload (typically including the encapsulation header, IP and TCP or UDP header) to the completion engine for insertion in the CQE, for further processing by software on host processor 24.

In the embodiments described above, it was assumed that each IPoIB packet encapsulates a complete IP packet in its payload. Alternatively, an IP packet may be fragmented among the payloads of a sequence of IB packets. (Preferably, the IP packet is encapsulated in the packets of a multi-packet IB message, which is transmitted using the IB Reliable Connection or Unreliable Connection transport services. In this manner, fabric 26 can be used to carry IP packets that are larger than the maximum payload size [MTU] for a single IB packet.) In this case, when the first IB packet of the sequence is received over fabric 26 by HCA 22 on a given QP, a checksum field in the corresponding QP context 36 is reset to zero. Verifier 102 computes the checksum value for this first packet, including the pseudo-header, TCP or UDP header and the part of the payload of the IP packet that is contained in the first IB packet, and places the value in the checksum field. For each subsequent IB packet in the sequence, verifier 102 computes the checksum value over the entire IB payload and adds the checksum value to the value already accumulated in the checksum field of the QP context, using suitable checksum arithmetic. After the last IB packet in the sequence is received, completion engine 84 inserts the final value of the checksum field into the CQE that it writes to memory 32, along with the IP_OK flag provided by verifier 102, as described above. (The IP_OK flag value may also be held in the QP context.) If the IP packet is itself an IP fragment, the methods described above for performing checksum calculations on 12 fragments are applied.

When HCA 22 is to send an IP packet by fragmenting it among the payloads of a multi-packet IB message, the problem of on-the-fly checksum computation is more complex: The complete checksum can be computed only after the tail of the IP packet has been gathered from memory 32 for insertion in the last IB packet in the sequence, but the checksum must be inserted in the IP packet header, in the first IB packet in the sequence. In order to circumvent this problem, host processor 24 may initially transmit an IB message containing the IP packet to itself, on a dedicated “service QP” provided on HCA 22. The sequence of packets in the TB message are looped back from output port 74 to input port 76, whereupon checksum verifier 102 computes the checksum value for the packet sequence, and completion engine 84 inserts the computed value in a CQE that it writes to memory 32. Processor 24 may then resend the IB message over fabric 26 to its actual destination, using the checksum value extracted from the CQE to create the IP and TCP or UDP headers, with the correct checksum values, in the first packet of the message. This method relieves processor 24 of the computational burden of calculating the checksum, although it does consume memory bandwidth and may incur added latency in packet transmission.

Although the preferred embodiments described herein make reference specifically to transmission of encapsulated IP packets over IB fabric 26, the principles of the present invention may similarly be applied to verification of encapsulated packets of other types, as well as to transmission of encapsulated packets over networks of other types. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A network interface adapter, comprising:
a memory interface, for coupling to a memory containing a first data packet composed in accordance with a first communication protocol;
a network interface, for coupling to a packet communication network; and
packet processing circuitry, which is adapted to read the first data packet from the memory via the memory interface, to compute a checksum of the first data packet and to insert the checksum in the first data packet in accordance with the first communication protocol, and to encapsulate the first data packet in a payload of a second data packet in accordance with a second communication protocol applicable to the packet communication network, so as to transmit the second data packet over the network via the network interface.

2. An adapter according to claim 1, wherein the first communication protocol comprises a transport protocol that operates over an Internet Protocol (IP).

3. An adapter according to claim 2, wherein the checksum comprises at least one of an IP checksum, a Transmission Control Protocol (TCP) checksum and a User Datagram Protocol (UDP) checksum.

4. An adapter according to claim 1, wherein the packet communication network comprises a switch fabric.

5. An adapter according to claim 4, wherein in accordance with the second communication protocol, the packet processing circuitry is adapted to transmit and receive data packets over the packet communication network using one or more queue pairs, including a selected queue pair over which the second data packet is to be transmitted, and
wherein the packet processing circuit is adapted to receive an indication that the selected queue pair is to be used for encapsulating and transmitting at least the first data packet composed in accordance with the first communication protocol, and to compute and insert the checksum responsive to the indication.

6. An adapter according to claim 4, wherein the packet processing circuitry is adapted to encapsulate the first data packet in the payload of the second data packet substantially as defined in a document identified as draft-ietf-ipoib-ip-over-infiniband-01, published by the Internet Engineering Task Force.

7. An adapter according to claim 1, wherein the network interface has a wire speed, and wherein the packet processing circuitry is adapted to compute the checksum at a rate that is at least approximately equal to the wire speed.

8. An adapter according to claim 7, wherein the wire speed is substantially greater than 1 Gbps.

9. An adapter according to claim 7, wherein the first communication protocol comprises a transport protocol that operates over an Internet Protocol (IP).

10. An adapter according to claim 9, wherein the checksum comprises at least one of an IP checksum, a Transmission Control Protocol (TCP) checksum and a User Datagram Protocol (UDP) checksum.

11. An adapter according to claim 7, wherein the packet communication network comprises a switch fabric.

12. An adapter according to claim 11, wherein in accordance with the second communication protocol, the packet processing circuitry is adapted to transmit and receive data packets over the packet communication network using one or more queue pairs, including a selected queue pair over which the second data packet is to be transmitted, and
wherein the packet processing circuit is adapted to receive an indication that the selected queue pair is to be used for encapsulating and transmitting at least the first data packet composed in accordance with the first communication protocol, and to compute and insert the checksum responsive to the indication.

13. An adapter according to claim 1, wherein the packet processing circuitry is adapted to read a descriptor from the memory via the memory interface and to generate the second data packet based on the descriptor, while determining whether or not to compute and insert the checksum in the first data packet responsive to a corresponding data field in the descriptor.

14. An adapter according to claim 1, wherein the packet processing circuitry is adapted to parse a header of the first data packet so as to identify a protocol type to which the first data packet belongs, and to compute the checksum appropriate to the identified protocol type.

15. An adapter according to claim 14, wherein the first data packet has an encapsulation header appended thereto, and wherein the packet processing circuitry is adapted to identify the protocol type by reading a field in the encapsulation header.

16. An adapter according to claim 14, wherein the processing circuitry is adapted, in accordance with the protocol type, to compute both a network layer protocol checksum and a transport layer protocol checksum, and to insert both the network layer protocol checksum and the transport layer protocol checksum in a header of the first data packet.

17. An adapter according to claim 1, wherein the packet processing circuitry comprises:
an execution unit, which is adapted to read from the memory descriptors corresponding to messages to be sent over the network, and to generate gather entries defining packets to be transmitted over the network responsive to the work items; and
a send data engine, which is adapted to read data from the memory for inclusion in the first data packet responsive to one or more of the gather entries, while computing the checksum.

18. An adapter according to claim 17, wherein the execution unit is further adapted, based on the descriptors, to generate a header of the second data packet in accordance with the second communication protocol.

19. An adapter according to claim 17, wherein the send data engine comprises:
a direct memory access (DMA) engine, which is adapted to read a succession of lines of the data from the memory, and to write the lines of the data to a buffer; and
a checksum computation circuit, which is coupled to receive the lines of the data in the succession from the DMA engine, to compute the checksum while the DMA engine is reading the succession of lines of the data from the memory, and to insert the checksum at a location in the first data packet designated in accordance with the first communication protocol when the DMA engine has completed reading the succession of lines of the data.

20. An adapter according to claim 1, wherein the packet processing circuitry comprises:
a send data engine, which is adapted to read data from the memory for inclusion in the first data packet, and using the data, to construct the second data packet, encapsulating the first data packet;
an output buffer, which is coupled to receive the second data packet from the send data engine; and
a checksum computation circuit, which is adapted to compute the checksum and to insert the checksum in the first data packet as the second data packet is transmitted out of the output buffer onto the network.

21. An adapter according to claim 20, wherein in accordance with the second communication protocol, the packet processing circuitry is adapted to transmit and receive data packets over the packet communication network using multiple queue pairs, including at least a first queue pair over which the second data packet is to be transmitted and a second queue pair for the data packets that are not to be used for encapsulating the first data packet, and
wherein the send data engine is adapted, upon constructing the data packets for transmission over the second queue pair, to send the data packets directly for transmission onto the network while bypassing the output buffer.

22. An adapter according to claim 1, wherein the packet processing circuitry is further adapted to receive from the network a third data packet encapsulating a fourth data packet as the payload of the third data packet, and to calculate one or more checksums in the fourth data packet in accordance with the first communication protocol.

23. A network interface adapter, comprising:
a memory interface, for coupling to a memory;
a network interface, which is adapted to be coupled to a packet communication network so as to receive from the network a second data packet in accordance with a second communication protocol applicable to the packet communication network, the second data packet encapsulating a first data packet composed in accordance with a first communication protocol; and
packet processing circuitry, which is coupled to receive the second data packet from the network interface, to compute a checksum of the first data packet in accordance with the first communication protocol, and to write the first data packet to the memory via the memory interface, together with an indication of the checksum.

24. An adapter according to claim 23, wherein the packet processing circuitry is adapted to compare the computed checksum to a checksum field in a header of the first data packet, so as to verify the checksum field, and
wherein the indication of the checksum indicates whether the checksum field was verified as correct.

25. An adapter according to claim 24, wherein the packet processing circuitry is adapted to determine a disposition of the first data packet responsively to verifying the checksum.

26. An adapter according to claim 25, wherein the packet processing circuitry is adapted to discard the second data packet when the checksum is found to be incorrect.

27. An adapter according to claim 23, wherein the first communication protocol comprises a transport protocol that operates over an Internet Protocol (IP).

28. An adapter according to claim 27, wherein the checksum comprises at least one of an IP checksum, a Transmission Control Protocol (TCP) checksum and a User Datagram Protocol (UDP) checksum.

29. An adapter according to claim 23, wherein the packet communication network comprises a switch fabric.

30. An adapter according to claim 29, wherein the packet processing circuitry is adapted to process the second data packet substantially as defined in a document identified as draft-ietf-ipoib-ip-over-infiniband-01, published by the Internet Engineering Task Force.

31. An adapter according to claim 29, wherein in accordance with the second communication protocol, the packet processing circuitry is adapted to transmit and receive data packets over the second communication network using one or more queue pairs, including a selected queue pair over which the second data packet is received, and
wherein the packet processing circuit is adapted to receive an indication that the selected queue pair is to be used for receiving at least the second data packet that encapsulates the first data packet composed in accordance with the first communication protocol, and to compute the checksum responsive to the indication.

32. An adapter according to claim 23, wherein the network interface has a wire speed, and wherein the packet processing circuitry is adapted to compute the checksum at a rate that is at least approximately equal to the wire speed.

33. An adapter according to claim 32, wherein the wire speed is substantially greater than 1 Gbps.

34. An adapter according to claim 32, wherein the first communication protocol comprises a transport protocol that operates over an Internet Protocol (IP).

35. An adapter according to claim 34, wherein the checksum comprises at least one of an IP checksum, a Transmission Control Protocol (TCP) checksum and a User Datagram Protocol (UDP) checksum.

36. An adapter according to claim 32, wherein the packet communication network comprises a switch fabric.

37. An adapter according to claim 36, wherein in accordance with the second communication protocol, the packet processing circuitry is adapted to transmit and receive data packets over the packet communication network using one or more queue pairs, including a selected queue pair over which the second data packet is received, and
wherein the packet processing circuit is adapted to receive an indication that the selected queue pair is to be used for receiving at least the second data packet that encapsulates the first data packet composed in accordance with the first communication protocol, and to compute the checksum responsive to the indication.

38. An adapter according to claim 23, wherein the packet processing circuitry is adapted to parse a header of the first data packet so as to identify a protocol type to which the first data packet belongs, and to compute the checksum in accordance with the identified protocol type.

39. An adapter according to claim 38, wherein the first data packet has an encapsulation header appended thereto, and wherein the packet processing circuitry is adapted to identify the protocol type by reading a field in the encapsulation header.

40. An adapter according to claim 23, wherein the packet processing circuitry is adapted to write a completion report to the memory, indicating whether or not the checksum was found to be correct.

41. An adapter according to claim 23, wherein the packet processing circuitry is adapted to write a completion report to the memory and to insert the computed checksum in the completion report, for use by a host processor in verifying a checksum field in the header of the first packet.

42. An adapter according to claim 23, wherein the second data packet is one of a sequence of second data packets, which encapsulate respective fragments of the first data packet, and wherein the packet processing circuitry is adapted to compute respective partial checksums for all fragments as the packet processing circuitry receives the second data packets, and to sum the partial checksums in a checksum arithmetic operation in order to determine the checksum of the first data packet.

43. An adapter according to claim 42, and comprising a send data engine, which is adapted to generate the second data packets for transmission over the network in accordance with the second communication protocol, and an output port, which is coupled to loop back the second data packets to the packet processing circuitry, so as to cause the packet processing circuitry to determine the checksum of the first data packet, for insertion of the checksum in an initial second data packet in the sequence before transmission of the sequence of the second data packets over the network.

44. A method for coupling a host processor and a system memory associated therewith to a network, comprising:
reading from the system memory, using a network interface adapter device, a first data packet composed by the host processor in accordance with a first communication protocol; and
performing the following steps in the network interface adapter device:
computing a checksum of the first data packet;
inserting the checksum in the first data packet in accordance with the first communication protocol;
encapsulating the first data packet in a payload of a second data packet in accordance with a second communication protocol applicable to the network; and
transmitting the second data packet over the network.

45. A method according to claim 44, wherein the first communication protocol comprises a transport protocol that operates over an Internet Protocol (IP).

46. A method according to claim 45, wherein the checksum comprises at least one of an IP checksum, a Transmission Control Protocol (TCP) checksum and a User Datagram Protocol (UDP) checksum.

47. A method according to claim 44, wherein the packet communication network comprises a switch fabric.

48. A method according to claim 47, wherein in accordance with the second communication protocol, the network interface adapter device is adapted to transmit and receive data packets over the network using one or more queue pairs, including a selected queue pair over which the second data packet is to be transmitted, and
wherein inserting the checksum comprises receiving an indication that the selected queue pair is to be used for encapsulating and transmitting at least the first data packet composed in accordance with the first communication protocol, and inserting the checksum responsive to the indication.

49. A method according to claim 47, wherein encapsulating the first data packet comprises constructing the second data packet substantially as defined in a document identified as draft-ietf-ipoib-ip-over-infiniband-01, published by the Internet Engineering Task Force.

50. A method according to claim 44, wherein the network is characterized by a wire speed, and wherein computing the checksum comprises calculating the checksum at a rate that is at least approximately equal to the wire speed.

51. A method according to claim 50, wherein the wire speed is substantially greater than 1 Gbps.

52. A method according to claim 50, wherein the first communication protocol comprises a transport protocol that operates over an Internet Protocol (IP).

53. A method according to claim 52, wherein the checksum comprises at least one of an IP checksum, a Transmission Control Protocol (TCP) checksum and a User Datagram Protocol (UDP) checksum.

54. A method according to claim 50, wherein the packet communication network comprises a switch fabric.

55. A method according to claim 54, wherein in accordance with the second communication protocol, the network interface adapter device is adapted to transmit and receive data packets over the network using one or more queue pairs, including a selected queue pair over which the second data packet is to be transmitted, and wherein inserting the checksum comprises receiving an indication that the selected queue pair is to be used for encapsulating and transmitting at least the first data packet composed in accordance with the first communication protocol, and inserting the checksum responsive to the indication.

56. A method according to claim 44, wherein encapsulating the first data packet comprises reading a descriptor from the system memory, and generating the second data packet based on the descriptor and wherein inserting the checksum comprises determining whether or not to insert the checksum in the first data packet responsive to a corresponding data field in the descriptor.

57. A method according to claim 44, wherein computing the checksum comprises parsing a header of the first data packet so as to identify a protocol type to which the first data packet belongs, and computing the checksum appropriate to the identified protocol type.

58. A method according to claim 57, wherein the first data packet has an encapsulation header appended thereto and wherein parsing the header comprises identifying the protocol type by reading a field in the encapsulation header.

59. A method according to claim 57, wherein computing the checksum comprises computing, in accordance with the protocol type, both a network layer protocol checksum and a transport layer protocol checksum, and wherein inserting the checksum comprises inserting both the network layer protocol checksum and the transport layer protocol checksum in a header of the first data packet.

60. A method according to claim 44, wherein computing the checksum comprises calculating the checksum on the fly, while reading the first data packet from the system memory.

61. A method according to claim 44, and comprising:
receiving from the network, using the network interface adapter device, a third data packet encapsulating a fourth data packet as the payload of the third data packet; and
verifying the checksum in the fourth data packet, using the network interface adapter device, in accordance with the first communication protocol.

62. A method for coupling a host processor and a system memory associated therewith to a network, comprising:
receiving from the network, using a network interface adapter device, a second data packet in accordance with a second communication protocol applicable to the network, the second data packet encapsulating a first data packet composed in accordance with a first communication protocol; and
performing the following steps in the network interface adapter device:
computing a checksum of the first data packet in accordance with the first communication protocol; and
writing the first data packet to the memory together with an indication of the checksum.

63. A method according to claim 62, and comprising, in the network interface adapter, comparing the computed checksum to a checksum field in a header of the first data packet, so as to verify the checksum field, wherein writing the first data packet together with the indication comprises indicating whether the checksum field was verified as correct.

64. A method according to claim 63, and comprising, in the network interface adapter, determining a disposition of the first data packet responsively to verifying the checksum.

65. A method according to claim 64, wherein determining the disposition comprises discarding the second data packet when the checksum is found to be incorrect.

66. A method according to claim 62, wherein the first communication protocol comprises a transport protocol that operates over an Internet Protocol (IP).

67. A method according to claim 66, wherein the checksum comprises at least one of an IP checksum, a Transmission Control Protocol (TCP) checksum and a User Datagram Protocol (UDP) checksum.

68. A method according to claim 62, wherein the packet communication network comprises a switch fabric.

69. A method according to claim 68, wherein the second data packet encapsulates the first data packet substantially as defined in a document identified as draft-ietf-ipoib-ip-over-infiniband-01, published by the Internet Engineering Task Force.

70. A method according to claim 68, wherein in accordance with the second communication protocol, the network interface adapter device is adapted to transmit and receive data packets over the second communication network using one or more queue pairs, including a selected queue pair over which the second data packet is received, and
wherein computing the checksum comprises receiving an indication from the memory that the selected queue pair is to be used for receiving at least the second data packet that encapsulates the first data packet composed in accordance with the first communication protocol, and calculating the checksum responsive to the indication.

71. A method according to claim 62, wherein the network is characterized by a wire speed, and wherein computing the checksum comprises calculating the checksum at a rate that is at least approximately equal to the wire speed.

72. A method according to claim 71, wherein the wire speed is substantially greater than 1 Gbps.

73. A method according to claim 71, wherein the first communication protocol comprises a transport protocol that operates over an Internet Protocol (IP).

74. A method according to claim 73, wherein the checksum comprises at least one of an IP checksum, a Transmission Control Protocol (TCP) checksum and a User Datagram Protocol (UDP) checksum.

75. A method according to claim 71, wherein the packet communication network comprises a switch fabric.

76. A method according to claim 75, wherein in accordance with the second communication protocol, the network interface adapter device is adapted to transmit and receive data packets over the network using one or more queue pairs, including a selected queue pair over which the second data packet is received, and
wherein computing the checksum comprises receiving an indication from the memory that the selected queue pair is to be used for receiving at least the second data packet that encapsulates the first data packet composed in accordance with the first communication protocol, and calculating the checksum responsive to the indication.

77. A method according to claim 62, wherein computing the checksum comprises parsing a header of the first data packet so as to identify a protocol type to which the first data packet belongs, and computing the checksum in accordance with the identified protocol type.

78. A method according to claim 77, wherein the first data packet has an encapsulation header appended thereto, and wherein parsing the header comprises identifying the protocol type by reading a field in the encapsulation header.

79. A method according to claim 62, wherein writing the first data packet to the memory together with the indication of the checksum comprises writing a completion report to the memory, indicating whether or not the checksum was found to be correct.

80. A method according to claim 79, wherein writing the first data packet to the memory together with the indication of the checksum comprises inserting the computed checksum in a completion report, and writing the completion report to the memory, for use by the host processor in verifying a checksum field in the header of the first packet.

81. A method according to claim 62, wherein receiving the second data packet comprises receiving a sequence of second data packets, which encapsulate respective fragments of the first data packet, and wherein computing the checksum comprises computing respective partial checksums for all fragments while receiving the second data packets, and summing the partial checksums in a checksum arithmetic operation in order to determine the checksum of the first data packet.

82. A method according to claim 81, and comprising generating the second data packets for transmission over the network in accordance with the second communication protocol, and looping the second data packets back through the network interface adapter device, so as to cause the network interface adapter device to determine the checksum of the first data packet, for insertion of the checksum in an initial second data packet in the sequence before transmission of the sequence of the second data packets over the network.
